(19) United States
(12) Patent Application Publication
(10) Pub. No.: US 2014/0279385 A1
(43) Pub. Date: Sep. 18, 2014

(54) SYSTEM FOR RATING REAL ESTATE LOAN QUALITY

(71) Applicant: LPS IP HOLDING COMPANY, LLC, Jacksonville, FL (US)

(72) Inventors: Daniel Brian Sogorka, Encinitas, CA (US); Donald P. Smith, Houston, TX (US); Bob Jennings, Encinitas, CA (US); Andrew Higginbotham, Chesterfield, MO (US)

(21) Appl. No.: 13/836,421

(22) Filed: Mar. 15, 2013

(51) Int. Cl. G06Q 40/02

(52) U.S. Cl. CPC G06Q 40/025
USPC 705/38

(57) ABSTRACT

Disclosed is a system for assessing the quality of real estate loan and reporting a relative score. Also disclosed are methods of compiling an aggregate of loan data from various data sources and techniques for reconciling and prioritizing conflicting data values. Further disclosed are methods for reassessing loan quality based on a given set of loan data, and a user defined evaluation date for selecting the rules that will be in effect for a given loan quality assessment.

### BACKGROUND

The mortgage-related downturn in the U.S. economy, occurring in the late 2000's, has resulted in a renewed emphasis on the quality of the loan manufacturing process and adherence to investor requirements. Recently, the government sponsored entities (GSEs) set forth the Uniform Mortgage Data Program (UMDP), calling for more standardized data requirements for loan data. Included in UMDP are new data requirements for delivery of mortgage loans known as Uniform Loan Delivery Dataset (ULDD). As of July 2012, all mortgages sold to the GSEs must conform to the new ULDD standards. In addition to the ULDD data requirements, there is a renewed focus on ensuring data and mortgage document accuracy. In today's environment, a lender's ability to address quality control is extremely laborious, time consuming, expensive, and inefficient. The loan manufacturing process includes numerous challenges in the area of quality: verifying eligibility criteria, maintaining data integrity, enforcing data consistency, performing data reconciliation, data transparency, and ensuring document accuracy. To address these challenges of loan quality, lenders have resorted to elaborate quality control processes. Lenders must enlist a significant number of resources to check and recheck loan data and documents using the “stare and compare” methodology. Typically, quality efforts include multiple internal and external systems, manually tracking efforts, and time consuming remediation processes. Manual quality control efforts are not only time consuming and costly, but have proven to be inconsistent at best.

### SUMMARY

A system for rating the quality of a real estate loan is disclosed. The system calculates a loan quality assessment using a set of loan quality rating rules and generates a report identifying areas of concern with respect to loan data completeness, accuracy, and consistency, among other things. Also disclosed are techniques for compiling loan data information from numerous sources into an aggregate of loan data values. Included as well are procedures for assigning a data priority to the data values based on, for example the source of the data, and then using the assigned priority to reconcile conflicts between data values coming from the same or different sources.

In another aspect, the system includes methods for processing a loan quality assessment for a given set of loan data using different sets of quality assessment rules. The rules each include an assigned effective start date and effective end date, thus a user selected evaluation date can be used to select the effective rules to be used for the assessment. By selecting different dates, a user is able to evaluate a given set of data repeatedly at different times with different rules, resulting in quality assessments which can then be compared.

### BRIEF DESCRIPTION OF THE DRAWINGS

FIG. 1 is a flowchart illustrating the overall operation of one embodiment of a system for rating the quality of a real estate loan.

FIG. 2 is a flowchart illustrating details regarding building a collection of loan data values for the system of FIG. 1.

FIG. 3 is a flowchart illustrating further detail regarding building a collection of loan data values for the system of FIG. 1.

FIG. 4 is an example of a loan quality assessment report generated by the system of FIG. 1.

FIG. 5 is a flowchart illustrating additional steps for reassessing loan quality using the system of FIG. 1.

### DETAILED DESCRIPTION

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

Illustrated in FIG. 1 at 100 is one embodiment of a method for rating the quality of a real estate loan implemented on a computer 118. FIG. 1 outlines the system in general terms, with further details added in subsequent figures and described below. A loan assessment request is made (102) for a given real estate loan causing the system to collect and maintain relationships between numerous pieces of loan related information (104) from multiple data sources 114. This data may include various electronic files and documents in an individual or compiled form containing a wide range of information about the property, the borrower, credit history, and the like. Examples of data sources include Uniform Loan Delivery Dataset uploads and commercial service providers such as Appraisal data sources, Valuation services, Mortgage Insurance reporting services, Flood data services, Title reporting services, and others. The data provided from these data sources will be used in assessing the quality of the submitted loan information.

It is not uncommon for an individual piece of data to appear from multiple sources (for example, the borrower's name). The system handles this aspect by implementing a priority scheme for the various data sets and assigns a priority (106) to the loan data values, for example based on the data source that the particular data value was received from. The assignment of priorities to data values is controlled by one or more pre-assigned data priority rules, such as the hierarchy shown in Table A below. In Table A, an example of data source assignment rules is shown where a numerical value is assigned to each loan data value according to its data source:

TABLE A
Example Data Priority Assignment Rules

| Value | Definition |
|---|---|
| 0 | No Specific Authority* |
| 1 | Reserved for Future Growth |
| 2 | Data Source is Loan Quality Services Request or |
| | Response/Document* |
| 3 | Data Source is a Loan Quality Services Response/Document* |
| 4 | Data Source is a ULDD Upload File |
| 5 | Reserved for Future Growth |

*The data priority varies for a data value based on the particular Loan Quality Service and/or Document from which it was received

The assignment of priorities to data values can occur in conjunction with collecting data values into repository (104). It should be noted that other types of data priority values can be used as well such as a broad range of numbers, decimal based numbers, letters, a mixture of letters and numbers, colors or any other suitable distinguishing information.

Preferably, a loan data aggregate (or “the aggregate”) is compiled (108) which contains the selected loan data values from the repository that will be used in the loan quality assessment process. The aggregate preferably has filtered the data values from the repository to select the desired values to be used in the evaluation and to select the most preferred data value for any piece which may have been supplied from multiple sources. The system populates the aggregate with the data values retrieved from the various data sources mentioned above according to the data priority assigned to each value. An example of this process for populating the aggregate is illustrated further in FIG. 2, and further examples of how the data priorities can be used to resolve data conflicts during population of the aggregate are shown in further detail in FIG. 3.

Optionally, the aggregate may also store and maintain all information (for example, source and timestamp) indicating where each data value is obtained, whether the data value is the most preferred value or not. This enables the system to also be used to track the history of a given data value. For example, data values can be compared across several data sources. It can then be reported (separately or as part of an overall report) if or how a value changes. In certain scenarios the fact that the data value changed, or the amount of change, may be a report element flag for further review in the loan evaluation process.

As further illustrated in FIG. 1, the system performs a loan quality assessment (110) by evaluating the aggregated loan data against one or more loan quality scoring rules associated with the aggregate. Each rule may include, for example, a severity level which serves as an indication of its relative importance. The system then compiles the results from the evaluation of the aggregate and generates a report (112) which can be made available to the user in various formats such as a PDF or an electronic data feed such as XML. An example report is shown in FIG. 4 and described below.

The date and time the quality assessment was made, as well as the aggregate data set, and the rule set used are saved in the repository making it possible to replay the assessment against the rule set using any selected effective date for the rules. An assessment may also be “refreshed” which results in an updated assessment using current data based on the rule set with the current date for the effective date. Examples of the “replay” functionality are illustrated further in FIG. 5

Illustrated in FIG. 2 is one embodiment of the process of populating the loan data aggregate with a set of loan data values. The assembled set of potential new or replacement values is iterated over beginning at 202 where the system gets the first data value and its priority from the set (i.e. the repository) (202) and accesses the data priority (204) to determine whether the data value is a new data value or a potential replacement value (206). The data value can be considered a new value if no corresponding value exists in the aggregate, and it can be thought of as a proposed replacement value if a corresponding value already exists in the aggregate. If this is a new value, the new value is written into the aggregate (212) and the next data value is read from the set of values (202) if there are more data values to process (216).

If the data value is a potential replacement value, the system determines if the data priority for the potential replacement value equals or exceeds the data priority of the existing data value in the aggregate (208). If so, the replacement data value overwrites the existing data value (214). Alternately, if the data priority of the potential replacement value is less than the data priority for the existing value in the aggregate, the replacement value is ignored (210) and the remaining data values in the set are processed (216). Processing continues (202) unless no more loan data values are available in the collection (216), in which case aggregate processing is complete (218).

Although assigning a data priority to the loan data values in the collection based solely on source provides a prioritization mechanism for selecting one value over another, it may not resolve all conceivable conflicts. As values are introduced into the aggregate, the possibility exists that both the potential replacement data value and the corresponding aggregate value may have the same data priority. This scenario can arise, in one instance, when two different data values are presented to the aggregate originating from the same data source, but at different times during loan processing. In another instance, two values may appear from two different data sources of equal priority.

The data priority rules preferably are able to resolve such a conflict. For example, in one embodiment each source-based data priority is also associated with a timestamp indicating when the data value was verified or submitted. In this embodiment, if the replacement data value and the aggregate data value have the same source-based data priority, then the timestamp is used to determine the most recent value, which is placed in the aggregate and the older value is discarded or ignored. An example of this rule in operation is illustrated in FIG. 3 at 300 where the “borrower name” data value is retrieved from multiple data sources and placed in the aggregate according to the procedures and rules discussed with respect to FIG. 3 with reference to the procedure illustrated in FIG. 2 as well.

Beginning at 302, a data value for “borrower name” is retrieved from the current set of data values where the data source is a Loan Quality Services response document. As discussed above with respect to Table A, the system assigns a data priority to data values based on the data source. In this example, the system assigned a numerical value of 3 as the data priority for the data value retrieved at 302.

As processing continues, the system determines whether the “borrower name” loan data field has been populated (304) in the aggregate (shown at 342). Having determined that this is a new data value (304), the system writes the value of “borrower name” retrieved at 302 into the aggregate (306). The state of “borrower name” then appears in the aggregate 342 as shown at 308.

Another data value from the collection of data values is then processed at 310, this value also originating from a Loan Quality Services response document, but at the later date and time of Mar. 12, 2013 at 1:00. The system checks aggregate 342 to determine if a value exists (312) for the “borrower name” field. In this case, it determines that this is a potential replacement value because a corresponding data value already exists in the aggregate. However, because the new data value came from the same source, it has the same source-based data priority (the numerical value “3” as shown at 308 and 318). Therefore when the data priority rules shown in FIG. 2 are executed at 314, a simple comparison of data priority between the new data value and the aggregate data value will not resolve the question of which data value should be in the aggregate.

However, as discussed above, in the illustrated embodiment, the time stamps indicating when the two data values were received by the system can also be considered. In this example, the potential replacement data value from 310 has a later time stamp of Mar. 12, 2013 than the aggregate data value with a time stamp of Mar. 1, 2013 (see 308). Therefore, in this embodiment of the data priority rules, the more recent replacement value will be used and replaces the data value in the aggregate at 316 even though both the replacement value and the aggregate data value have the same source-based data priority (318).

As aggregate processing continues, another data value for the “borrower name” field is encountered at 320, this time having a Verification of Identity response as the data source with a source-based data priority of two. As before, the system determines this is a potential replacement value because the “borrower name” field is already populated (322) in aggregate 342. However, in this example, the aggregate is not overwritten with the potential replacement value (326) because the aggregate value has a higher source-based priority of 3. The data priority rules at 324 compare the data priority of the existing value (3) to the potential replacement data priority value (2) and will maintain the higher priority value already in aggregate 342 rather than replacing it. Therefore the aggregate data for “borrower name” remains as before (328).

In the last example shown in FIG. 3, another replacement data value for the “borrower name” field is processed at 330 having originated from a ULDD upload and thus having a source-based data priority of 4. As this data value already exists (332) in aggregate 342, and the data priority of four is higher than the data priority for the corresponding aggregate data value with a data priority of three, the existing aggregate value is replaced (336). The “borrower name” field value appears afterward as shown at 338. Processing continues (340) as shown in the FIGS. 2 and 3 until all data values in the collection have been considered.

In another aspect, as illustrated in FIG. 3, the same data value may be available from multiple data sources. However, it may also be the case that a reoccurrence of a given data field from several sources may be a cause for an increased level of scrutiny. It might be the case that receiving “borrower name” from six different data sources is no cause for concern, but that having three different actual names presented by all three data providers might be. Aggregate processing offers the opportunity to monitor and track this type of data discrepancy for inclusion in the assessment, or for separate reporting and tracking outside the normal loan quality assessment process.

Using the assembled aggregate, a loan quality report can be generated as shown in FIG. 1 at 112. When the quality report is requested, the overall quality assessment for a specific set of loan data is determined by the system as of that specific point in time. The system performs its quality assessment analysis on loan data values from the aggregate using one or more loan quality scoring rules which embody various evaluation criteria (i.e. quality thresholds). In one embodiment, the system processes the loan data calculating a quality-concern level (for example, “stop”, “warning”, “alert”, or “informational”) for each loan data value by comparing that data value to various quality thresholds for that particular loan data field as defined in the evaluation criteria.

Table B shows a number of examples of various loan quality scoring rules and their corresponding quality concern level. In table B, the left column gives a description of the rule logic and the data fields involved in determining the quality assessment. Data fields such as the appraisal value, the year the subject property was built, the buyer's income history, the number of undisclosed properties identified, and many others, may be evaluated. Examples are shown for “STOP, “ALERT”, “WARN”, and “INFORMATIONAL” levels, but other levels or level indicators such as numerical values may be implemented in other embodiments as well.

TABLE B
Example Loan Quality Assessment Rules

| Rule Logic Explanation | Severity |
|---|---|
| Credit report completed within 90 days of note date | STOP |
| Appraisal value is missing | STOP |
| Invalid Submission: File too large | STOP |
| The year that the subject property was built contains an | ALERT |
| invalid value or is missing from the file. | |
| The indicator to determine if flood insurance is on the | ALERT |
| loan contains an invalid value or is missing from the | |
| file. | |
| Address is reported as located in a flood zone. | ALERT |
| The Application Received Date contains an invalid | ALERT |
| date or is missing from the file. | |
| The indicator to determine if the borrower's mailing | ALERT |
| address is the same as the subject property address | |
| contains an invalid value or is missing from the file. | |
| The Assumability Indicator contains an invalid value | ALERT |
| or is missing from the file. | |
| The indicator to designate the subject loan as a | ALERT |
| construction loan contains an invalid value or is | |
| missing from the file. | |
| The indicator to determine if a credit repository source | ALERT |
| is available contains an invalid value or is missing | |
| from the file. | |
| The income reported is greater than the wages, salaries | WARN |
| and tips reported on the IRS transcript for tax year | |
| 2009 | |
| The income reported is equal or less than the, salaries | WARN |
| and tips reported on the IRS transcript for tax year | |
| 2010 | |
| Potential occupancy misrepresentation identified: | WARN |
| Mortgage Application states Owner Occupied, a search | |
| against the public record could not confirm | |
| Number of undisclosed properties identified: 2 | WARN |
| Property unit number is missing: Property Type is a | WARN |
| Condo, Subject Property Unit blank on Mortgage | |
| Application | |
| VOE Check was not completed within 14 days of | WARN |
| Scheduled Closing Date | |
| Fannie Mae and Freddie Mac currently do not require | INFORM- |
| any ULDD elements for related loans. | ATIONAL |
| Fannie Mae and Freddie Mac do not conditionally | INFORM- |
| require any ULDD elements for assets, liabilities, and | ATIONAL |
| expenses. Since these data points are not required, the | |
| ULDD Data Completeness Check section indicates | |
| both Fannie Mae and Freddie Mac Conditionally | |
| Required components for A/L &Exp as 100% complete | |
| and the Overall Loan Assessment is not impacted. | |
| The ULDD optional data points are collected in | INFORM- |
| anticipation of future use by Fannie Mae and Freddie | ATIONAL |
| Mac. Since these data points are optional, the ULDD | |
| Data Completeness Check section indicates both | |
| Fannie Mae and Freddie Mac Optional components as | |
| 100% complete and the Overall Loan Assessment is | |
| not impacted. | |

The system, in one embodiment, evaluates the aggregate loan data values against one or more loan quality rules, examples of which are shown above in Table B. In the embodiment shown, each rule generates a quality concern of a particular level for the loan data value in the aggregate depending on the result. Lastly, after analyzing all of the data values in the aggregate, the system can also generate reports such as a single overall quality rating assessment based on the quantity and level of each quality concern found. A report summarizing and detailing the various quality concerns is generated at 112 (see FIG. 1).

One example of a final loan quality report is illustrated in FIG. 4 at 400. Various resulting quality concerns are grouped into sections of related loan data. In this embodiment of the report, a header 402 includes specific loan information such as the report date, loan number, client, evaluation criteria set, loan purpose, loan type, property type, occupancy type, “borrower name”, sales price, appraised value, loan amount, and loan to value ratios. Other fields may be included as well.

If the system has produced an overall quality rating, the overall quality assessment section 404 may then also appear in the resulting report, such as the report 400 shown in FIG. 4. Overall quality assessment section 404 may further include a quality assessment indicator 414, here embodied as a colored flag accompanied by an assessment label 422. Section 404 may also include a short narrative summarizing how the assessment can impact loan risk, while also showing other information such as the total number of elements found that matched a given quality-concern level. The overall quality rating is determined, in one embodiment, by the type and number of quality concerns. For example, if a single element in the report is evaluated as a “stop”, it might result in an overall assessment of “low quality” for the loan. If no elements in the report are evaluated as “stop”, but at least one element is evaluated as a “warning”, the overall loan assessment might be rendered with “moderate quality” indicators. Similarly, if the report has no elements that have been evaluated as “stop” or “warning”, then the overall assessment might be shown as “high quality”.

Report 400 may also include a loan quality services section 406 indicating the loan origination services 420 that could impact the quality of this loan, such as Appraisal, Valuation Insight Report, Mortgage Insurance, Flood, and Title to name a few. Also included in section 406 (and in the sections discussed below), is an overall assessment indicator for each section at 416A, 416B, 416C, and 416D, each offering a visual indication of the overall assessment of the concerns calculated for the respective sections. These indicators may be numeric, textual, or as in the illustrated embodiment, graphical including icons, colors, shapes and the like.

A lender compliance check section 410 may also be included in report 400 listing, for example, the compliance checks required by the lender such as Good Faith Estimate (GFE) checks and a Verification of Employment check. A Data Completeness Check section 412 may also appear in the report indicating, for example, the percentage of data completeness for ULDD elements of interest to Fannie Mae and Freddie Mac such as Property, Borrower, Other Parties, Subject Loan, Related Loan, and Assets/Liabilities & Expenses, and these elements may be required, conditionally required or optional.

In some embodiments, the report shown at 400 may be only a summary page summarizing a body of more detailed information that follows in subsequent pages. All of the quality concerns found for a given data value may then be shown in a detailed report following after the summary page, while the report summary (for example as shown in FIG. 4) may only show an icon corresponding to the quality concern that most negatively impacts the loan quality. For example, if data for the Appraisal report element is analyzed against six criteria, resulting in five “informational” concerns and one “warning” concern, all six results will be listed in the report details while the report summary may only show only an icon alerting the viewer the further information is available elsewhere in the report.

Lastly, information about the date and time of when the report was created may also be included (424), as well as information indicated the effective date for the rules used in generating the report. This information is helpful because reports like report 400 present the outcome of an assessment of loan data at a particular point in time with a given effective date for the rules used to generate the assessment. This facilitates the comparison of one report with another.

All of the loan quality rules used by the system to process a quality assessment for a given loan form an overall rule set. Each rule typically embodies one or more evaluation criteria applied to one or more data values, implemented to support the outcome of the assessment.

The overall set of quality assessment rules may include rules which are and which are not currently in effect and/or which were in effect at various different times, but which are retained in the set. Typically, each quality assessment rule in the overall rule set includes an assigned effective start date and an assigned effective end date which dictate when each rule is in effect. Therefore when a particular evaluation date is specified, the date can be used to select/compile a subset of the rules in effect as of the specified evaluation date. Thus, a request to evaluate a given set of data for a particular evaluation date will result in some of the rules being disregarded if the evaluation date is before the effective start date or after the assigned effective end date.

One option is to run a “replay” procedure effectively applying different rule sets to the same data. Examples of how a replay procedure could be implemented are illustrated in FIG. 5 at 500. A user selects a data set and an evaluation date and the system compiles a collection of rules in effect as of the specified date from the overall rule set. For example, the system removes from consideration expired rules or rules that were not yet in effect as of the selected date. By selecting different dates, the user can modify the rule set and reassess the loan quality repeatedly and compare the results. For example, choosing an evaluation date that matches the creation date of the data set results in the original assessment. Choosing a date from after the creation date of the dataset evaluates the data as if it were being assessed some time after its actual creation date and may include rules not in effect at the time. Lastly, choosing a date prior to the evaluation date evaluates the loan data for an effective set of rules from prior to when the data set was created.

As shown in FIG. 5, a user selects a data set (502), for example, from a list of loan files or data sets as of a specific creation date and previously stored in the repository which is then processed into an aggregate, or alternately, a previously generated and stored aggregate. In another embodiment, selecting the loan data involves the system processing effective dates associated with data values to compile the data values in effect on a selected dataset date. The user may also select an evaluation date (504), which the system processing uses to determine the rule set in effect on the evaluation date (506). The user selected dataset aggregate is then processed (508) using the selected effective rule set to generate a report (510).

In some cases a user may repeat the process by selecting a second evaluation date and generating a second report using the same data set and comparing the results between the first and second reports. This process might be used, for example, when a lender wants to know how a new set of government regulations related to loan origination will effect quality assessments. In that case, the lender selects the previously executed assessment and selects, for example, the current date as the first evaluation date (504).

The first report would be generated based on rules associated with the dataset in effect today. The lender might then select the second evaluation date for the second report to be a date in the future after the new rules will be in effect. The second report would then be based on a second working set containing rules set to go into effect sometime in the future. The resulting reports generated by each set of rules can then be compared and analyzed.

Alternately, the system may run a “refresh” procedure including updating the loan data with the most recent data, and then applying the rules associated with the current date as the effective date.

The generation of the first and second assessment reports discussed above might be separated by hours, days, months, or any other suitable amount of time larger or smaller. Also a “user” might be an entity such as a company, or outside system issuing automated requests, or an outside system sending requests initiated by a human, rather than a human being. For example, a large company may automatically initiate numerous loan assessment requests for a particular group of loans every week until they are processed to track changes in the assessment. The resulting reports may be evaluated by another computer and might not be viewed by a human being unless the processing system flags them for review.

Similarly, the “user” initiating the request at 502 may or may not be the same system or human being initiating the second request at 506. The comparison may also be made by a separate automated system, or possibly by the loan quality assessment system itself as an additional step in the processing. Furthermore, the same or another “user” may be making the comparison at 510. For example, it may be the case in a large organization for one person to initiate the request for an assessment, and perhaps for another person to receive both first and second reports passing them along to third person, or group of people, for the analysis.

Turning to implementation specifics, in the illustrative embodiment, the system can operate as software executing on computer 118 (see FIG. 1) which may include one or more processors or CPUs and one or more types of memory. Each memory preferably includes a removable memory device. Each processor may be comprised of one or more components configured as a single unit. Alternatively, when of a multi-component form, a processor may have one or more components located remotely relative to the others. One or more components of each processor may be of the electronic variety defining digital circuitry, analog circuitry, or both. In one embodiment, each processor is of a conventional, integrated circuit microprocessor arrangement, such as one or more PENTIUM, i3, i5 or i7 processors supplied by INTEL Corporation of 2200 Mission College Boulevard, Santa Clara, Calif. 95052, USA.

Each memory (removable or generic) is one form of a computer-readable device. Each memory may include one or more types of solid-state electronic memory, magnetic memory, or optical memory, just to name a few. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM); an optical disc memory (such as a DVD or CD ROM); a magnetically encoded hard disc, floppy disc, tape, or cartridge media; or a combination of any of these memory types. Also, each memory may be volatile, nonvolatile, or a hybrid combination of volatile and nonvolatile varieties.

Computer 118 represents a “computer” in the generic sense and may be a single, physical, computing device such as a desktop computer, a laptop computer, or may be composed of multiple devices of the same type such as a group of servers operating as one device in a networked cluster, or a heterogeneous combination of different computing devices also linked together by a network and operating as one computer. Thus computer 118 may be composed of one or more physical computing devices having one or more processors and memory as described above.

Computer 118 may also include a virtual computing platform having an unknown or fluctuating number of physical processors and memory devices supporting the operation of the systems described above. Likewise, computer 118 may be located in one geographical location or spread across several widely scattered locations with multiple processors linked together to operate as a single computer connected by a network. Just as the concept of a computer is not limited to a single physical device, so also the concept of a “processor” is not limited to a single physical logic circuit or package of circuits but includes one or more such circuits or circuit packages possibly contained within or across multiple computing machines in various physical locations.

The concept of “computer” and “processor” within a computer or computing device also encompasses any such processor or computing device serving to make calculations or comparisons as part of disclosed system. Processing operations related to threshold comparisons, rules comparisons, calculations, and the like occurring in computer 118 may occur, for example, on separate servers, the same server with separate processors, or on a virtual computing environment having an unknown number of physical processors as described above.

In one embodiment, computer 118 is coupled to a display and/or includes an integrated display. Likewise, displays may be of the same type, or a heterogeneous combination of different visual devices. Although not shown, each computer may also include one or more operator input devices such as a keyboard, mouse, touch screen, laser or infrared pointing device, or gyroscopic pointing device to name just a few representative examples. Also, besides a display, one or more other output devices may be included such as a printer or plotter. As such, various display, input and output device arrangements are possible.

The data and operating logic of the system described above can be embodied in signals transmitted over a network, in programming instructions, dedicated hardware, or a combination of these. Thus communications with the system can be achieved by various means such as a wireless or wired Local Area Network (LAN), Municipal Area Network (MAN), Wide Area Network (WAN), such as the Internet, a combination of these, or such other network arrangements as would occur to those skilled in the art.

External data sources may also be connected to the system via data access devices connect to these same communications links, or by data access devices may provide data by other means such as via nonvolatile storage devices such as DVD or CD-ROM, flash memory devices, and the like. Users may also interact with the system by submitting appraisals over the same networks or by receiving the resulting reports by nonvolatile copies or by other means. It shall be appreciated that in alternate forms a user may submit loan information and view reports generated by the system as well as other relevant loan information on computing devices such as a PDAs, Blackberries, iPhones, iPads, smart phones or tablet computers, to name just a few illustrative examples.

In one embodiment, users interact with the system via one or more software applications operating on computer 118 which serves HTML pages, sends and receives data via web services, and/or other Internet standard or company proprietary data formats, or maintains dedicated client/server connections in order to facilitate the transfer of information between the user and the system, or between the system and outside datasources. As described above, this interaction can take place over a network such as the internet, a WAN, MAN, LAN, or other suitable electronic communications network. Further, it shall be appreciated that the types of communication methods connected within the above described system need not be of the same type, but that digital, analog, and other technologies may be accommodated simultaneously.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected. In addition, all references cited herein are indicative of the level of skill in the art and are hereby incorporated by reference in their entirety.

What is claimed is:

1. A computer implemented method for rating the quality of a real estate loan, comprising:
collecting one or more data values from one or more loan data sources to create a loan data aggregate;
assigning a data priority to each loan data value;
receiving a replacement data value having a replacement data priority, the replacement data value being proposed to replace an existing data value in the loan aggregate;
using a processor in a computing device to compare the data priority of the replacement data value to the data priority of the existing loan data value using one or more data priority rules and replacing the existing data value in the loan aggregate with the replacement data value if the data priority of the replacement data value is higher than the priority value of the existing data value; and,
generating a loan quality report and quality rating using the processor and an algorithm applying loan quality rating rules to the data values in the loan data aggregate.

2. The method of claim 1, wherein the data priority assigned to each loan data value is based upon a source of the data value.

3. The method of claim 2, wherein if the data priority of the replacement data value is the same as the data priority of the existing loan data value, then the priority rules replace the existing data value with the replacement data value if the timestamp of the replacement data value is later than the timestamp of the existing data value.

4. The method of claim 2, wherein the data priority assigned to each loan data value is a numerical value.

5. The method of claim 1, wherein the loan quality report includes information about the one or more loan data sources.

6. A computer implemented method for creating a loan data aggregate used in rating the quality of a real estate loan, comprising:
collecting a set of a plurality of loan data values from one or more sources to be placed into a loan data aggregate;
assigning a data priority to each loan data value;
using a processor to process the loan data values, including:
a) selecting a loan data value from the set;
b) placing the loan data value into the loan data aggregate if the loan data value does not yet exist in the aggregate;
c) if the loan data value exists in the aggregate, then comparing the data priority of the loan data value to the data priority of the existing data value using one or more data priority rules and replacing the existing data value in the loan aggregate with the loan data value if the data priority of the loan data value is higher than the priority value of the existing data value;
repeating the steps of using the processor to process the loan data values for each loan data value in the set of loan data values;
generating a loan quality report and quality rating using the processor and an algorithm applying loan quality rating rules to the data values in the loan data aggregate.

7. The method of claim 6, wherein the data priority assigned to each loan data value is based upon a source of the data value.

8. The method of claim 7, wherein the data priority assigned to each loan data value includes a timestamp, and if the source-based data priority of the replacement data value is the same as the source-based data priority of the existing loan data value, then the priority rules replace the existing data value with the replacement data value if the timestamp of the replacement data value is later than the timestamp of the existing data value.

9. The method of claim 7, wherein said one or more sources comprises at least two difference sources.

10. The method of claim 9, wherein the data priority between at least two difference sources is determined based on a numerical value.

11. The method of claim 7, wherein said one or more sources comprises the same source with different timestamps.

12. The method of claim 11 wherein the data priority between the same source with different timestamps is based on selecting the one with the more recent timestamp.

13. A computer implemented method for rating the quality of a real estate loan, comprising:
accessing a loan data file with loan data values using a processor in a computing device, the processor being coupled to a data access device for accessing the loan data file, wherein the loan data file is associated with a rule set of loan quality scoring rules;
selecting a dataset from a list of one or more datasets identified by a creation date;
selecting an evaluation date that is prior to, the same, or after the creation date;
processing the evaluation date to choose an evaluation rule set; and
generating a loan quality report for the quality of a real estate loan by applying the chosen evaluation rule set to the data set.

14. The method of claim 13, wherein the data set is selected from a list of previously generated data sets.

15. The method of claim 13, wherein the data set is compiled by selecting the data values in effect on the creation date.

16. The method of claim 13, wherein each rule in the rule set of loan quality scoring rules has an effective start date and an effective end date.

17. The method of claim 16, wherein the rule set is compiled by selecting rules in effect on the evaluation date from an overall rule set.

18. The method of claim 13, wherein the rule set is selected from a list of previously generated rule sets.

19. The method of claim 13, further comprising:
selecting a second evaluation date that is prior to, the same, or after the creation date;
processing the second evaluation date to choose a second evaluation rule set; and
generating a second loan quality report for the quality of the real estate loan by applying the second evaluation rule set to the data set.
comparing the loan quality report with the second loan quality report.
